(19) United States
(12) Patent Application Publication
(10) Pub. No.: US 2002/0156882 A1
(43) Pub. Date: Oct. 24, 2002

(54) Method and system for identifying event source in duplicate IP networks

(76) Inventors: Srikanth Natarajan, Fort Collins, CO (US); Darren D. Smith, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/838,205

(22) Filed: Apr. 20, 2001

(51) Int. Cl. G06F 15/173; G06F 15/177

(52) U.S. Cl. 709/224; 709/220

(57) ABSTRACT

A method and system are described for identifying the source of an event in a computer network. In accordance with exemplary embodiments of the present invention, an identifier tag is associated with an event occurring within the computer network, wherein the identifier tag uniquely identifies at least one collection computer monitoring the event. At least one management computer receives information from the at least one collection computer that includes the identifier tag. The at least one management computer derives an identification of each collection computer from the identifier tag. The source of the event is identified to a user using the identification of each collection computer.

### BACKGROUND

1. Field of the Invention

The present invention relates to computer networks. More particularly, the present invention relates to identifying the source of events in duplicate Internet Protocol (IP) computer networks.

2. Background Information

Management stations connected to a network are often configured by a management software package to discover the network topology, for example, the network nodes and node interconnections. From the network topology, the station constructs a network management map, which comprises a collection of various sub-maps. Each sub-map corresponds with a different view of the network and any sub-map can be displayed on a display device. These sub-maps can be arranged in a hierarchy.

For example, a network management map implemented in the known “OPENVIEW”™ management software, commercially available from the Hewlett-Packard Company, U.S.A., has a root sub-map defined at a root level representing the highest logical level sub-map in the hierarchy and shows objects acting as anchor points for different sub-map hierarchies, each hierarchy being a separate management domain, for example, a network, logical grouping of nodes, or some other domain. An Internet sub-map is defined at an Internet level and is generated by exploding an object (i.e., providing more data regarding the object) within the root sub-map. This process of exploding can be iteratively repeated to any desired level of detail.

Hewlett-Packard's “OPENVIEW”™ Network Node Manager (NNM) product, for example, has an event management subsystem which manages events from network elements, performs correlation on the events, and displays the events in a graphical user interface (GUI). An event can be any action or occurrence that is generated by a network element, such as a network element going down or coming up. One of the key data pieces the event management subsystem uses to identify the source of an event is the Internet Protocol (IP) address of the network element generating the event. The source data is used to display information in the GUI, to do correlations, and to store the source data in an event store.

In managing computer networks, difficulties can arise when different networks use identical (duplicate) IP addresses. A duplicate IP address can be a repeated IP host/interface address, a repeated hostname, or a repeated network name or address. Duplicate IP addresses can occur when different companies use the same private or unregistered IP addresses. Duplicate IP addresses can also occur as a result of, for example, improperly configured network devices in which network elements in the same collision domain are communicating with the same IP address or two network nodes have the same hostname. Duplicate IP addresses can also occur as a result of stand-by router configurations (where the router and its stand-by use the same IP address).

A problem arises when a network manager attempts to identify the source of an event in environments having duplicate IP addresses occurring across companies, because network management products use IP addresses as the source of the event in their event databases or their GUIs. For example, when two event sources have the same IP address are stored and/or displayed to a user, the true source of the event cannot be determined by the user.

One technique for addressing duplicate IP address issues using NNM is to have network managers deploy NNM in a distributed fashion. When NNM is deployed in a distributed manner, collection stations forward events that they receive to a management station. As a part of the event information that they forward, the collection stations send either the name or the IP address of the network element which generated the event as the source of the event. For purposes of discussion, the term “IP address” will be used to refer to both the name and the IP address of the network element in question. When a NNM management station receives an event forwarded from a collection station or collection station domain (i.e., a group of collection stations deployed to monitor a particular customer's network), this forwarding technique does not correctly inform the user of the source of the event if two events coming from different collection station groups have the same IP address. Management station-collection station concepts are discussed in, for example, U.S. Pat. No. 5,948,055 (Pulsipher et al.), the disclosure of which is hereby incorporated by reference in its entirety.

Other techniques have been implemented which attempt to address the problem of identifying event source in duplicate IP networks. For example, events of different collection stations can be displayed in a single console window, but separating them within that window in different containers based on the forwarding collection station. However, this technique does not provide the network manager with a consolidated event view of all the customer networks or elements that the network manager is managing.

It would be desirable to provide an improved method to easily identify the source of an event in a network environment having duplicate IP addresses occurring across companies.

### SUMMARY OF THE INVENTION

A method and system are described for identifying the source of an event in a computer network. In accordance with exemplary embodiments of the present invention, an identifier tag is associated with an event occurring within the computer network, wherein the identifier tag uniquely identifies at least one collection computer monitoring the event. At least one management computer receives information from the at least one collection computer that includes the identifier tag. The at least one management computer derives an identification of each collection computer from the identifier tag. The source of the event is identified to a user using the identification of each collection computer.

### BRIEF DESCRIPTION OF THE DRAWING FIGURES

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a block diagram illustrating a network 100 in which the source of an event can be identified in accordance with an exemplary embodiment of the present invention;

FIG. 2 is a flow chart showing steps for identifying the source of an event in a computer network in accordance with an exemplary embodiment of the present invention;

FIG. 3 is a block diagram illustrating protocol data units without and with event tagging in accordance with an exemplary embodiment of the present invention; and

FIGS. 4A and 4B are graphical presentations of event source information in accordance with exemplary embodiments of the present invention.

### DETAILED DESCRIPTION OF THE PREFERRED EMBODIMENTS

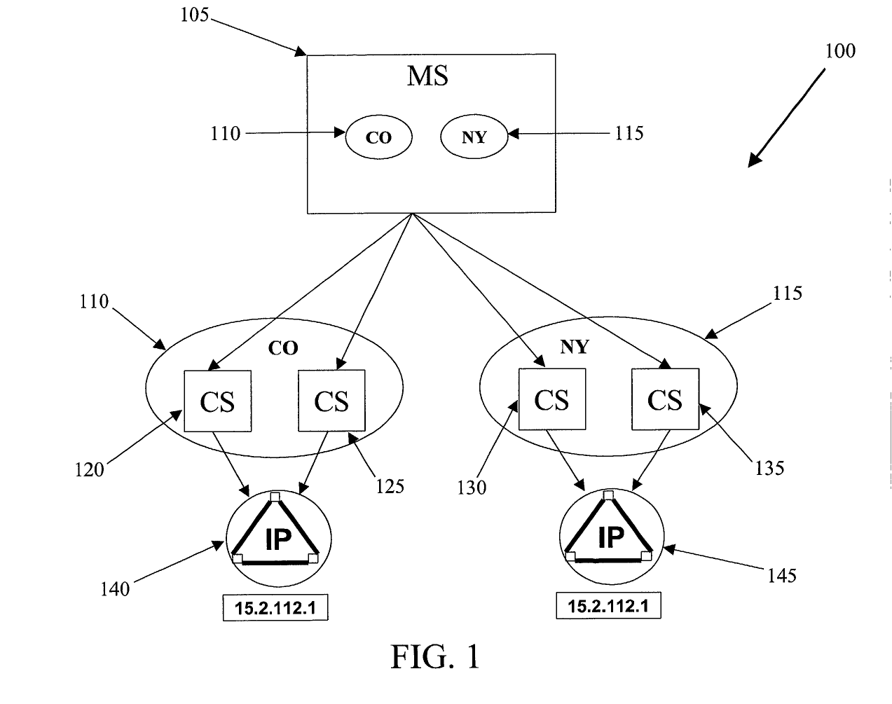

FIG. 1 is a block diagram illustrating a network 100 in which the source of an event can be identified in accordance with an exemplary embodiment of the present invention. According to an exemplary embodiment of the present invention, network 100 can include a plurality of collection computers, wherein an identifier tag uniquely identifies each collection computer, and wherein the identifier tag is associated with an event occurring within the computer network. In an exemplary embodiment of the present invention, the collection computers can be, for example, collection stations 120, 125, 130, and 135.

Network 100 can also include at least one management computer for receiving information from the plurality of collection computers that includes the identifier tag, wherein each management computer derives an identification of each collection computer from the identifier tag. In an exemplary embodiment of the present invention, the management computer can be, for example, management station 105. Network 100 can also include means for identifying to a user the source of the event using the identification of each collection computer. Collection stations and management stations are described in, for example, the U.S. Pat. No. 5,948,055.

As shown in FIG. 1, collection stations can be deployed to monitor computer networks within, for example, remote customer sites. In FIG. 1, collection stations 120 and 125 have been deployed to monitor a first computer network 110 (e.g., a customer site designated as “CO”), while collection stations 130 and 135 have been deployed to monitor a second computer network 115 (e.g., a customer site designated as “NY”). In FIG. 1, each of first and second computer networks 110 and 115, respectively, can be connected to at least one management station, for example, management station 105. Within first computer network 110, a first network element 140 is designated by any IP address, for example, “15.2.112.1”, that is unique within the first computer network. Within second computer network 115, a second network element 145 is designated by any IP address, for example, “15.2.112.1”, that is unique within the second computer network. However, in FIG. 1, between first computer network 110 and second computer network 115, the designated IP address of, for example, “15.2.112.1” is not unique. Thus, as can be seen in FIG. 1, collection stations have been deployed at different customer sites, where the different customer sites have duplicate IP addresses between them. However, those of ordinary skill will recognize that different customer sites can have not only duplicate IP addresses between them, but also duplicate network names and duplicate hostnames.

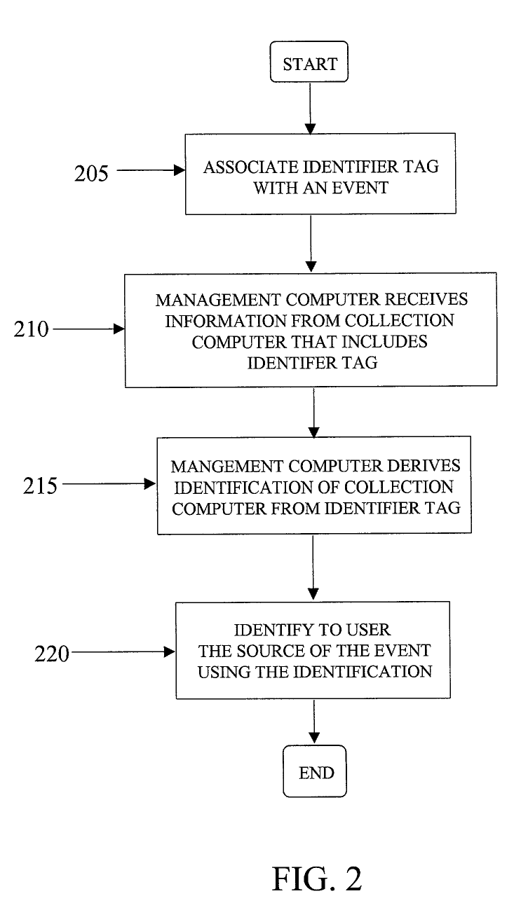

An exemplary method for identifying the source of an event in a computer network will be described with reference to FIG. 2. In step 205, an identifier tag can be associated with an event occurring within the computer network, wherein the identifier tag uniquely identifies at least one collection computer monitoring the event. According to an exemplary embodiment of the present invention, the identifier tag can be, for example, the name or domain name of the at least one collection computer. Alternatively, for the identifier tag, for example, a customer name can be used as a group name for a group of collection computers residing at a customer site. In addition, a unique name can be assigned to each collection computer residing in the customer site. However, any identifier tag that uniquely identifies at least one collection computer can be associated with an event.

In NNM, for example, events are represented as Simple Network Management Protocol (SNMP) traps. A SNMP trap has several variable bindings in the payload of the trap that carry information about the event. Each variable binding is an object identification (ID) and an object value pair. Each object ID is in the dotted notation (e.g., 0.1.3.4.5.6) and represents the identifier for a variable. The value part contains the actual value for that variable.

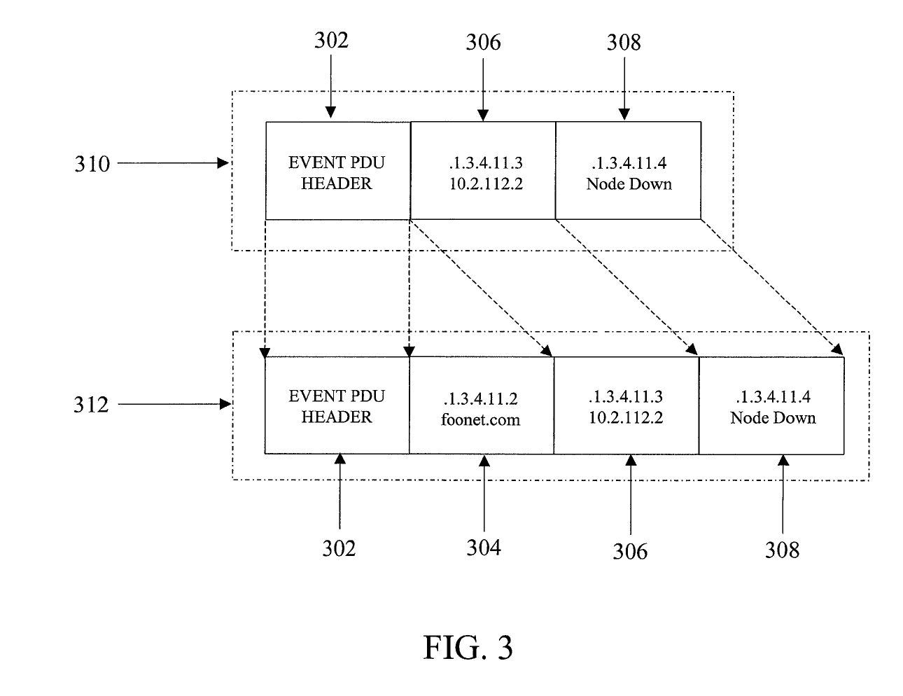

In an exemplary embodiment of the present invention, another variable binding can be added to events that are forwarded to, for example, a management station. This additional variable binding can be used to send the identifier tag, such as, for example, the name or domain name, of the collection station or group of collection stations monitoring the event. This additional variable binding can be referred to as event tagging. An illustration of the additional variable binding will be described with reference to FIG. 3. As an example of a Protocol Data Unit (PDU) that can be used to report events in NNM, PDU 310 from a collection station named “foonet.com” represents a sample network node down event PDU that contains an event PDU header 302 and two variable binding pairs 306 and 308, respectively. In variable binding pair 306 of PDU 310, “.1.3.4.11.3” is the object ID that corresponds to the object value of “10.2.112.2” that is the IP address of a network node which is down (i.e., the source of the event). In the second variable binding pair of PDU 310, “.1.3.4.11.4” is the object ID that corresponds to the object value of “Node Down” that is the message describing the event. However, although PDU 310 contains an indication that an event (e.g., a node down event) has occurred, there is no indication of the entity (e.g., the collection station named “foonet.com”) reporting the event.

In an exemplary embodiment, an additional variable binding can be added to PDU 310 to form modified PDU 312. In modified PDU 312, Event PDU Header 302 and variable bindings 306 and 308 can remain the same. However, in accordance with an exemplary embodiment of the present invention, variable binding 304 can be added to the PDU to identify at least one collection computer monitoring the event. In variable binding 304, “.1.3.4.11.2” is the object ID that corresponds to the object value of “foonet.com” that is the identifier tag, such as, for example, the name or domain name, of the collection computer or group of collection computers monitoring the event.

In step 210, at least one management computer (e.g., management station 105) receives information from the at least one collection computer (e.g., collections station 120, 125, 130, and 135) that includes the identifier tag. Thus, according to an exemplary embodiment of the present invention, the event tagging can send with every event an identifier tag that can contain the identifier, such as, for example, the name or domain name, of the collection computer or group of collection computers from where the event came. In NNM, for example, the management stations and collections stations have an event management process known as the postmaster daemon. When a computer is configured as a collection station, the postmaster daemon in the collection station determines to which management station events are to be forwarded. Only those events in the collection station that are configured to be forwarded to the management station are actually forwarded.

In step 215, at least one management computer derives an identification of the collection computer from the identifier tag that can be included in the information received at the management computer. In accordance with an exemplary embodiment of the present invention, when a management computer receives the event information including the identifier tag and when the management computer needs to display or use the source of an event, the management computer can, for example, derive the domain name of the collection computer from the identifier tag contained in the event. Referring to modified PDU 312, if, for example, “FooNet” is the domain name associated with the identifier tag of, for example, “foonet.com”, then the management computer could derive the domain name “FooNet” from the identifier tag “foonet.com” contained in the event information. In an exemplary embodiment, a database of identification information associated with identifier tags can be maintained within the management computer. For example, the domain names associated with the identifier tags could be populated in a management computer database that can be accessed by the management computer each time event information is received.

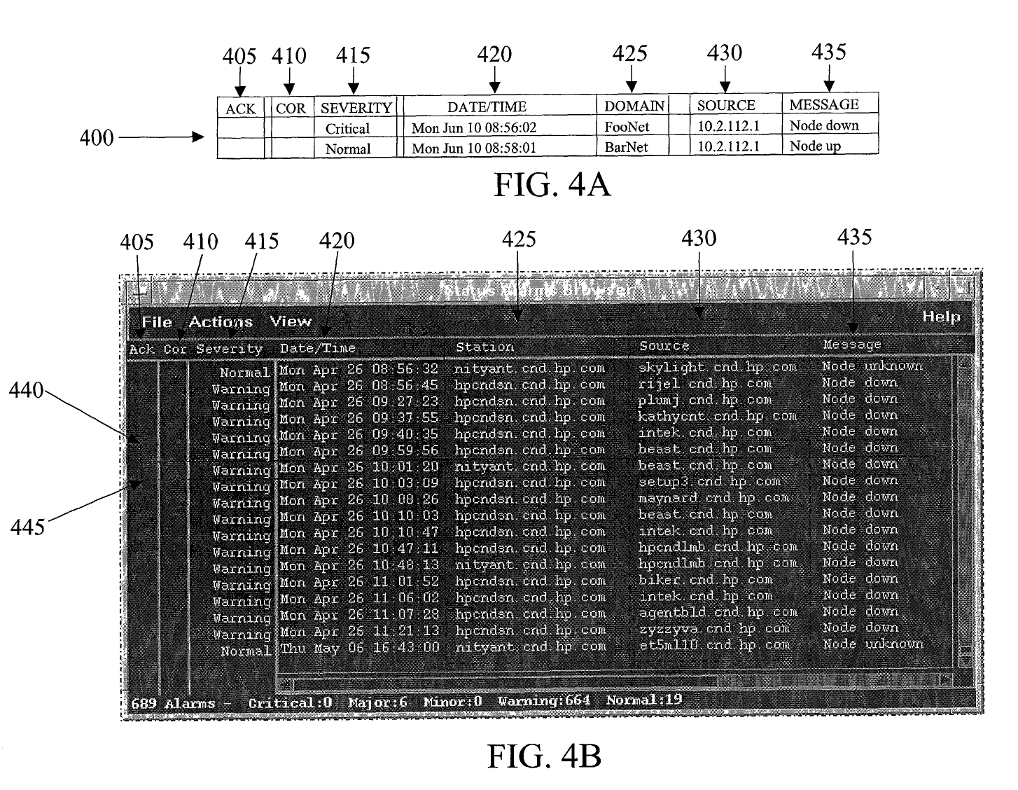

In step 220, the source of the event can be identified to a user using the identification of the collection computer. In an exemplary embodiment, the source of the event can be identified to a user by displaying to the user the identification of the at least one collection computer and a network address (e.g., the IP address) of the network element which generated the event. In an alternate exemplary embodiment, the identifier tag can be used to map the collection computer to a group of collection computers, which can be referred to as a “domain.” In this alternate exemplary embodiment, the source of the event can be identified to the user using the group of collection computers (e.g., their domain) and the network address (e.g., IP address) of the network element which generated the event. Examples of graphical presentations of event source information to a user are shown in FIGS. 4A and 4B.

In FIGS. 4A and 4B, acknowledge field 405 can represent whether an event has been acknowledged by an operator, correlation field 410 can represent whether an event is a correlated event or not, severity field 415 can represent the severity of an event, date-time field 420 can represent the date and time an event occurred, domain/station field 425 can represent the derived identification of the collection computer or group of collection computers reporting the event, source field 430 can represent the source address of the network object which generated the event, and message field 435 can represent the message describing the event. In an exemplary embodiment, the management computer can use the domain name (e.g., “FooNet”) derived from the identifier tag and source name (e.g., the IP address or domain name of the network node that is down) to uniquely identify the source of an event.

In table 400, for example, even though the sources (e.g., “10.2.112.1”) of the two events in source field 430 appear to be identical, the sources are actually different, because they originate from different domains. Using domain/station field 425 in accordance with an exemplary embodiment of the present invention, an operator at a management station can determine that the source of the two events are different because they originate from different domains (e.g., “FooNet” and “BarNet”, respectively). This is also illustrated in the graphical presentation of event source information to a user is shown in FIG. 4B, where even though the source of events 440 and 445 appear to be identical (e.g., “beast.cnd.hp.com”), the sources of the events are actually different, because they originate from different domains (e.g., “hpcndsn.cnd.hp.com” and “nityant.cnd.hp.com”, respectively). For example, in FIG. 4A, if no domain/station field 425 were available to the operator, the operator could conclude that the source (e.g., the network node) which was previously down had come back up, which would be an incorrect assessment of the state of the network nodes in the computer network.

According to an exemplary embodiment, each collection computer can manage at least one network object. A network object can be, for example, a computer, a router, another collection computer, or any other computer network device. The management computer (e.g., management station 105) can be configured to perform hostname resolution of the network objects that are managed by each collection computer. Alternatively, in accordance with exemplary embodiments, a collection computer (e.g., collection stations 120, 125, 130, and 135) can be configured to perform hostname resolution of the network object that they are managing. Consequently, each collection computer can resolve a network address of each network object. The resolved network address can be included in the information that is received at the at least one management computer. Performing hostname resolution by the collection computers can prevent management computers from failing because of an inability to resolve hostnames or because of the occurrence of duplicate hostnames.

It will be appreciated by those skilled in the art that the present invention can be embodied in other specific forms without departing from the spirit or essential character thereof. The presently disclosed embodiments are therefore considered in all respects to be illustrative and not restrictive. The scope of the invention is indicated by the appended claims rather than the foregoing description and all changes that come within the meaning and range of equivalents thereof are indicated to be embraced therein.

What is claimed is:

1. A method for identifying the source of an event in a computer network, comprising the steps of:
associating an identifier tag with an event occurring within the computer network, wherein the identifier tag uniquely identifies at least one collection computer monitoring the event;
receiving, in at least one management computer, information from the at least one collection computer that includes the identifier tag;
deriving, by the at least one management computer, an identification of each collection computer from the identifier tag; and
identifying to a user the source of the event using the identification of each collection computer.

2. The method of claim 1, wherein the identifier tag is a name of the at least one collection computer.

3. The method of claim 1, wherein the step of deriving comprises the step of:
maintaining within the at least one management computer a database of identification information associated with identifier tags.

4. The method of claim 1, wherein the step of identifying comprises the step of:
displaying to the user the identification of the at least one collection computer and a network address of a network element that generated the event.

5. The method of claim 1, wherein the step of identifying comprises the step of:
mapping each collection computer to a group of collection computers using the identifier tag; and
identifying to the user the source of the event using the group of collection computers and a network address of a network element that generated the event.

6. The method of claim 1, comprising the steps of:
managing, by the collection computer, at least one network object; and
resolving, by the collection computer, a network address of each network object into a resolved network address included in the information received at the at least one management computer.

7. A system for identifying the source of an event in a computer network, comprising:
a plurality of collection computers, wherein an identifier tag uniquely identifies each collection computer, and wherein the identifier tag is associated with an event occurring within the computer network;
at least one management computer for receiving information from the plurality of collection computers that includes the identifier tag, wherein each management computer derives an identification of each collection computer from the identifier tag; and
means for identifying to a user the source of the event using the identification of each collection computer.
